(19) United States
(12) Patent Application Publication
(10) Pub. No.: US 2021/0319324 A1
(43) Pub. Date: Oct. 14, 2021

(54) TECHNOLOGY FOR MEMORY-EFFICIENT AND PARAMETER-EFFICIENT GRAPH NEURAL NETWORKS

(71) Applicant: Intel Corporation, Santa Clara, CA (US)

(72) Inventors: Matthias Mueller, Munich (DE); Vladlen Koltun, Santa Clara, CA (US); Guohao Li, Munich (DE)

(73) Assignee: Intel Corporation, Santa Clara, CA (US)

(21) Appl. No.: 17/358,448

(22) Filed: Jun. 25, 2021

(51) Int. Cl. G06N 3/08; G06N 3/063

(52) U.S. Cl. CPC G06N 3/084; G06N 3/063

(57) ABSTRACT

Systems, apparatuses and methods may provide for technology that trains a reversible graph neural network (GNN) by partitioning an input vertex feature matrix into a plurality of groups, generating, via a block of the reversible GNN, outputs for the plurality of groups based on an adjacency matrix and an edge feature matrix, wherein the outputs are generated during one or more forward propagations, conducting a reconstruction of the input feature matrix during one or more backward propagations, and excluding the adjacency matrix and the edge feature matrix from the reconstruction. The technology also trains a deep equilibrium GNN.

### TECHNICAL FIELD

Embodiments generally relate to neural networks. More particularly, embodiments relate to technology for memory-efficient and parameter-efficient graph neural networks.

### BACKGROUND

Graphs that arise in practical applications may have billions of nodes and edges. Current graph neural networks typically struggle to learn on such huge graphs due to their limited parameter capacity. Memory complexity has become a significant barrier when training deep graph neural networks (GNNs) for practical applications due to the immense size of the nodes, edges, and intermediate activations.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a comparison of the memory complexity and parameter complexity of different GNNs according to embodiments;

FIG. 2 is a plot of an example of an area under the curve (AUC)-receiver operating characteristics (ROC) score versus graphics processing unit (GPU) memory consumption for different GNNs according to embodiments;

FIG. 3A is a flowchart of an example of a method of training a reversible GNN according to an embodiment;

FIG. 3B is a flowchart of an example of a method of generating outputs for a plurality of groups in a reversible GNN according to an embodiment;

FIG. 4 is a flowchart of an example of a method of training a deep equilibrium GNN according to an embodiment;

FIGS. 5A-5D are plots of examples of training results according to embodiments;

FIG. 6 is a block diagram of an example of a performance-enhanced computing system according to an embodiment;

FIG. 7 is an illustration of an example of a semiconductor package apparatus according to an embodiment;

FIG. 8 is a block diagram of an example of a processor according to an embodiment; and

FIG. 9 is a block diagram of an example of a multi-processor based computing system according to an embodiment.

### DESCRIPTION OF EMBODIMENTS

Existing works may try to overcome memory bottlenecks by mini-batch training, sampling a smaller set of nodes (Hamilton, Ying, and Leskovec 2017; Jianfei Chen, Zhu, and Song 2018; Jie Chen, Ma, and Xiao 2018) or partitioning large graphs (Chiang et al. 2019; Zeng et al. 2020) into smaller subgraphs and sampling from those. Mini-batching and partitioning approaches introduce further hyperparameters that need to be tuned. For instance, if the sampled size of nodes or subgraphs is too small, it may break important structures in the graph. These methods also do not scale as the models become deeper or wider, since memory consumption is still dependent on the number of layers.

Another approach is efficient propagation via the K-power adjacency matrices or graph diffusion matrices (Wu et al. 2019; Klicpera, Bojchevski, and Günnemann 2019; Bojchevski et al. 2020; Liu, Gao, and Ji 2020; Frasca et al. 2020). The efficient propagation methods use propagation schemes that are non-trainable, which may lead to sub-optimality.

Embodiments propose GNNs with constant memory complexity enabling very large overparameterized models. Embodiments develop graph neural networks with reversible connections, group convolutions, weight tying, and equilibrium model architectures to advance the memory efficiency and parameter efficiency of GNNs. Embodiments empirically show that by equipping models with these techniques, GNNs can achieve state-of-the-art performance on several datasets from the Open Graph Benchmark (OGB) while using significantly less memory. As one demonstration of the capability of embodiments, a GNN is trained with more than 1000 layers on a single commodity GPU, about one order of magnitude deeper than was possible before.

GNNs have been applied to many real-world problems that can create potential commercial value. For example, Amazon uses GNNs to learn representation on knowledge graphs for drug repurposing, which helps researchers to relocate existing drugs for treating new diseases such as COVID-19 and Alzheimer's disease. Utilizing GNNs, DeepMind and the Google Maps team improve the accuracy of the ETAs of Google Maps by 50% in cities like Berlin, Washington D.C., etc. Alibaba and Amazon employ recommender systems using GNNs. GNNs also have been used for detecting fraud and abuse, marketing and chip placement for designing hardware. Google has shown that graph neural networks combined with reinforcement learning can be used to minimize PPA (power, performance, and area) of a chip block. The proposed Efficient GNNs can enhance the large-scale hardware design such as chip placement.

Graphs are all around us. Whether an individual watches a show on Netflix, browses through friends' feeds on FACEBOOK, buys something on AMAZON, or look ups a researcher on GOOGLE, chances are that those actions trigger queries on a large graph. Movie and book databases are often encoded as knowledge graphs for efficient recommendation systems. Social media services rely on social graphs. Shopping platforms leverage product co-purchasing networks to boost sales. Citation indices like Web of Science, Scopus, and Google Scholar construct large citation graphs. Even the Internet itself is in essence a vast graph with billions of nodes and edges. Graphs are also powerful tools for representing 3D data such as point clouds and meshes or biological data such as molecular structures and protein interactions.

One prominent and powerful approach to process such graphs are graph neural networks (GNNs). GNNs have achieved impressive performance on relatively small graph datasets (Yang, Cohen, and Salakhudinov 2016; Zitnik and Leskovec 2017; Shchur et al. 2018). Unfortunately, the most interesting and impactful real-world problems rely on very large graphs where limited GPU memory quickly becomes a bottleneck. In order to train GNN models on large graphs, the number of model parameters needs to be reduced. This is counterproductive, since processing larger graphs would likely benefit from more parameters. There is evidence that over-parameterized models generalize better (Neyshabur et al. 2018; Belkin et al. 2019). The relationship between performance and parameters is best illustrated with the example of language modelling. Recent progress in natural language processing (NLP) has been enabled by a massive increase in parameter counts: GPT (110M) (Radford et al., n.d.), BERT (340M) (Devlin et al. 2018), GPT-3 (175B) (Brown et al. 2020), Gshard-M4 (600B) (Lepikhin et al. 2020), and DeepSpeed (1T) (Rasley et al. 2020). More parameters mean deeper or wider networks that consume more memory.

GNNs show considerable promise on recent large-scale graph datasets such as Open Graph Benchmark (OGB) (Hu et al. 2020) and Microsoft Academic Graph (MAG) (K. Wang et al. 2020). Recent works (Li et al. 2019, 2020; M. Chen et al. 2020) have successfully trained deep models with a large number of parameters and achieved state-of-the-art performance. These models, however, have large memory footprints and operate at the physical limits of current hardware. In order to apply deeper and wider GNNs with more parameters, either different hardware or more efficient architectures that consume less memory are needed.

Existing works may try to overcome the memory bottleneck by mini-batch training, sampling a smaller set of nodes (Hamilton, Ying, and Leskovec 2017; Jianfei Chen, Zhu, and Song 2018; Jie Chen, Ma, and Xiao 2018) or partitioning large graphs (Chiang et al. 2019; Zeng et al. 2020) into smaller subgraphs and sampling from those. These approaches have proven successful, but they introduce further hyperparameters that need to be tuned. For instance, if the sampled size of nodes or subgraphs is too small, it may break important structures in the graph. While these methods are a step in the right direction, they also do not scale as the models become deeper or wider, since memory consumption is still dependent on the number of layers. Another approach is efficient propagation via the K-power adjacency matrices or graph diffusion matrices (Wu et al. 2019; Klicpera, Bojchevski, and Günnemann 2019; Bojchevski et al. 2020; Liu, Gao, and Ji 2020; Frasca et al. 2020). However, the propagation schemes of these methods are non-trainable, which may lead to sub-optimality.

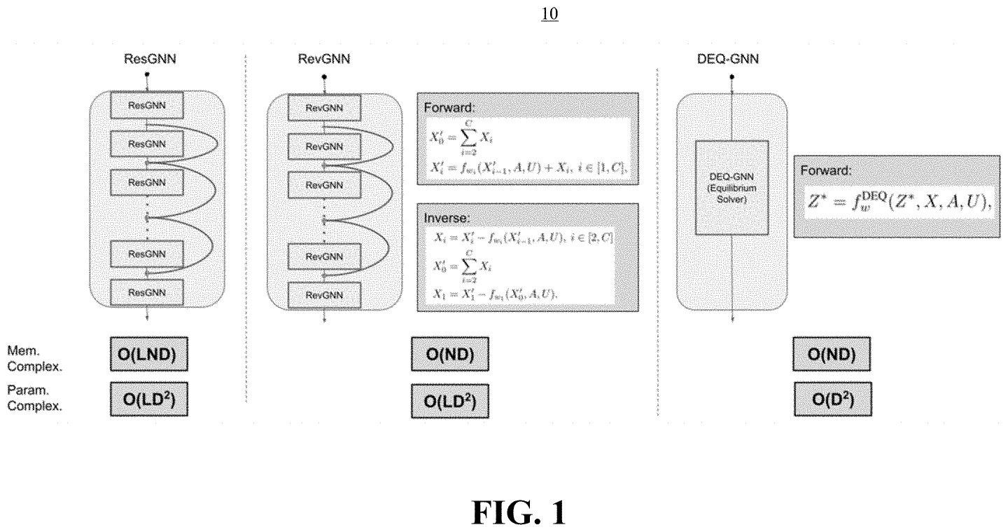

Inspired by efficient architectures from computer vision and natural language processing (Gomez et al. 2017; Xie et al. 2017; Bai, Kolter, and Koltun 2018, 2019), here embodiments investigate several methods to obtain more efficient GNNs that use less memory than conventional architectures while achieving state-of-the-art results (see, FIG. 1). Embodiments explore grouped reversible graph connections in order to reduce the memory complexity with respect to the number of layers from O(L) to O(l). In other words, the memory consumption is independent of the depth. This allows very deep, over-parameterized models to be trained with constant memory consumption.

Embodiments also investigate weight-tied GNNs to explore more parameter-efficient architectures. This allows very deep GNNs to be trained with the parameter cost of only a single layer. Finally, embodiments develop a deep graph equilibrium model, which is essentially a weight-tied network with infinite depth. Embodiments directly solve for the equilibrium point of this infinite-layer network using a root-finding method. Embodiments backpropagate through the equilibrium point using implicit differentiation. Hence, embodiments do not need to store intermediate states and get an infinite-depth network at the memory and parameter cost of a single layer.

Analysis of these methods shows that deep reversible architectures are the most powerful in terms of achieving state-of-the-art performance on benchmark datasets. This is due to their very large capacity, which comes with only minimal memory cost. Weight-tied models offer constant parameter size regardless of depth. However, due to the smaller number of parameters, performance on large datasets suffers and is compensated for by increasing the width. Finally, graph equilibrium models have the same memory efficiency as reversible models and the same parameter efficiency as weight-tied models. They perform similarly to weight-tied models and training time performance can be further adjusted by tuning the number of iterations in each optimization step.

Embodiments can be applied to different GNN operators. In experiments, embodiments are successfully applied to GCN (Kipf and Welling 2017), GraphSAGE (Hamilton, Ying, and Leskovec 2017), GAT (Veličković et al. 2018), and DeepGCN (Li et al. 2019). Embodiments can also combine the proposed techniques with sampling-based methods to further reduce memory and boost performance on some datasets. Embodiments are believed to be the first to train a GNN with more than 1000 layers. Our model RevGEN-Deep, outperforms all state-of-the-art approaches on the ogbn-proteins dataset (Hu et al. 2020) with a ROC-AUC of 87.06 while only consuming 2.86 GB of GPU memory, one order of magnitude less than the current top performer. Embodiments can also trade memory savings for larger width, pushing performance to new heights. RevGEN-Wide achieves an ROC-AUC of 87.41 on the ogbn-proteins dataset, ranking first on the leaderboard by a large margin.

In summary, embodiments investigate several techniques to increase the memory efficiency of GNNs and perform an extensive analysis across several datasets. Embodiments significantly outperform current state-of-the-art methods on several datasets by employing the presented techniques to train deeper and wider models. Further, embodiments demonstrate the generality of these techniques by applying them to multiple GNN architectures. Embodiments support both PyTorch Geometric (PyG) (Fey and Lenssen 2019) and the Deep Graph Library (DGL) (M. Wang et al. 2019) and will be made publicly available.

Methodology

Preliminaries

A graph [symbol] is represented by a tuple [symbol] = [symbol] , ε [symbol] , where [symbol] =v₁, v₂, . . . , v_{N} is an unordered set of vertices and ε⊆ [symbol] × [symbol] is a set of edges. Let N and M denote the number of vertices and edges respectively. For convenience, a graph can be equivalently defined as an adjacency matrix Aε [symbol] ⊂ [symbol] ^{N×N} where a_{i,j} denotes the link relation between vertex vᵢ and vⱼ. In some scenarios, vertices and edges are associated with a vertex feature matrix Xε [symbol] ⊂ [symbol] ^{N×D} and an edge feature matrix Uε [symbol] ⊂ [symbol] ^{M×F}, respectively.

Embodiments consider GNN operators that map the vertex feature matrix X, the adjacency matrix A, and the edge feature matrix U (optional) into a transformed vertex feature matrix X′:

f_{w} [symbol] × [symbol] × [symbol] [symbol] ′,

where f_{w}(X, A, U) is parameterized by learnable parameters w. For simplicity, embodiments assume that the transformed vertex feature matrix X′ has the same dimension as the input vertex feature matrix X. Embodiments also assume that the adjacency matrix A is the same for all GNN layers. When the edge feature matrix U is present, it is fed into each layer with its initial values U⁽⁰⁾. Recent works (Li et al. 2019, 2020) show how adding residual connections (He et al. 2016) to vertex features (X′=f_{w}(X, A, U)+X) enables training deep GNNs that achieve promising results on graph datasets. However, the memory complexity of the activations is [symbol] (LND), where L is the number of GNN layers, N is the number of vertices, and D is the hidden size of vertex features. Hence, the memory consumption of deep GNNs scales linearly with the number of layers. Since the memory footprint of the network parameters is usually negligible, embodiments focus on memory consumption induced by the activations.

Grouped Reversible GNNs

Inspired by reversible networks (Gomez et al. 2017; Liu et al. 2019; Kitaev, Kaiser, and Levskaya 2019) and grouped convolutions (Krizhevsky, Sutskever, and Hinton 2012; Xie et al. 2017), embodiments generalize reversible residual connections to grouped reversible residual connections for GNNs. Specifically, the input vertex feature matrix X is uniformly partitioned into C groups [symbol] X₁, X₂, . . . , X_{C} [symbol] across the channel dimension, where

$${X}_{i} ∈ {ℝ}^{N \times \frac{D}{C}} .$$

A grouped reversible GNN block operates on a group of inputs and produces a group of outputs: [symbol] X₁, X₂, . . . , X_{C} [symbol] X′₁, X′₂, . . . , X′_{C} [symbol] . The forward pass is defined as follows:

$${X}_{0}^{′} = {\sum }_{i = 2}^{C} {X}_{i}$$

$${X}_{i}^{′} = {f}_{{w}_{i}} ( {X}_{i - 1}^{′} , A , U ) + {X}_{i} , i ∈ [ 1 , C ] ,$$

where X′₀, is designed for exchanging information across groups. Unlike conventional GNNs, grouped reversible GNNs only need to save the output vertex features of the last GNN block in GPU memory for backpropagation. Therefore, the memory complexity of activations becomes [symbol] (ND), which is independent of the depth of the network. Note that the adjacency matrix A and the edge feature matrix U are not updated during message passing. During the backward pass, only the input vertex features are reconstructed, on the fly, from the output vertex features [symbol] X′₁, X′₂, . . . , X′_{C} [symbol] for backpropagation:

$${X}_{i} = {X}_{i}^{′} - {f}_{{w}_{i}} ( {X}_{i - 1}^{′} , A , U ) , i ∈ [ 2 , C ]$$

$${X}_{0}^{′} = {\sum }_{i = 2}^{C} {X}_{i}$$

$${X}_{1} = {X}_{1}^{′} - {f}_{{w}_{1}} ( {X}_{0}^{′} , A , U ) .$$

In practice, Xᵢ for iε[2, C] can be computed in parallel. To reconstruct X₁, X′₀, needs to be computed in advance. After reconstructing the original input vertex features, gradients can be derived through backpropagation. Owing to the group processing, the number of parameters reduces as the group size increases. Note that in the special case where the group size C=2, embodiments obtain a similar form to the reversible residual connections proposed for CNNs (Gomez et al. 2017). The definition above is independent of the choice of f_{w}. However, embodiments find that normalization layers and drop out layers are essential for training deep GNNs. To avoid extra memory usage, normalization layers and drop out layers are embedded into the reversible GNN block. The GNN block f_{w}_{ᵢ} is designed similarly as the pre-activation residual GNN block proposed by Li et al. (2020):

\hat{X}ᵢ=Drop out(ReLU(Norm(X′ᵢ₋₁)))

\hat{X}ᵢ=GraphConv(\hat{X}ᵢ, A, U).

The stochasticity of vanilla drop out layers would cause reconstruction errors in the reverse pass. A naive solution would be to store the drop out pattern for all layers. However, the drop out patterns have the same dimension as the activations, which would cause [symbol] (LND) memory consumption. As an alternative, embodiments adopt a modified drop out layer in which the drop out pattern is shared across layers. Therefore, embodiments only need to store one drop out pattern in every SGD iteration; its memory complexity is independent of the depth: [symbol] (ND). During the reverse pass, the saved drop out pattern is reactivated to reconstruct the input vertex features.

Weight-Tied GNNs

Weight-tying is a powerful tool for improving the parameter efficiency of language models (Press and Wolf 2017; Inan, Khosravi, and Socher 2016; Bai, Kolter, and Koltun 2018). Embodiments take these works as inspiration to study how weight-tying can improve the parameter efficiency of GNNs. Instead of having different weights for different GNN blocks, the weight-tied GNN shares weights across layers. The GNN model proposed by Scarselli et al. (2008) can be considered the first weight-tied GNN, in which a learned transition function is used to find stable node states by Banach's fixed point theorem (Khamsi and Kirk 2001). Here embodiments experiment with weight-tied residual GNNs and weight-tied reversible GNNs. For weight-tied residual GNNs, embodiments define:

f_{w}⁽¹⁾:=f_{w}⁽²⁾ . . . :=f_{w}^{(L)},

where L is the number of layers. For weight-tied reversible GNNs, weights are shared in a group-wise manner:

f_{w}_{ᵢ}⁽¹⁾:=f_{w}_{ᵢ}⁽²⁾ . . . :=f_{w}_{ᵢ}^{(L)}, i∈[1, C]

Note that embodiments use the same pre-activation GNN block described with respect to grouped reversible GNNs instead of a contraction map used by Scarselli et al. (2008). Both weight-tied GNNs have explicit layers and are trained with backpropagation. But the weight-tied reversible GNN reconstructs input vertex features on the fly during backpropagration. Therefore, the memory complexities of the weight-tied residual GNN and weight-tied reversible GNN are [symbol] (LND) and [symbol] (ND), respectively.

Deep Equilibrium GNNs

An alternative way to train weight-tied GNNs with [symbol] (ND) memory consumption is to use implicit differentiation (Scarselli et al. 2008; Bai, Kolter, and Koltun 2019; Gu et al. 2020), which assumes that the network can reach an equilibrium state. Embodiments construct a GNN model that is assumed to converge to a fixed point Z* for any given input:

Z*=f_{w}^{DEQ}(Z*, X, A, U),

where the state Z represents the transformed node features. To construct a stable or contractive GNN block, embodiments mimic the design of MDEQ (Bai, Koltun, and Kolter 2020). Embodiments build a GNN block as follows:
Z′=GraphConv(Zᵢₙ, A, U)
Z″=Norm(Z′+X)
Z′″=GraphConv(Drop out(ReLU(Z″)), A, U)
Zₒ=Norm(ReLU(Z′″+Z′)),
   where Zᵢₙ is the input node state, Zₒ is the output node state, X serves as the injected input and Z′ forms an internal residual signal to the output Zₒ. In practice, X represents the initial node features and Zᵢₙ is initialized to zeros for the first iteration. Similar to DEQ (Bai, Kolter, and Koltun 2019), the forward pass of DEQ-GNN is implemented with a root-finding algorithm (e.g., Broyden's method) and the gradients are obtained by implicitly differentiating through the equilibrium node state for the backward pass.

FIG. 3A shows a method 30 of training a reversible GNN. The method 30 may be implemented as one or more modules in a set of logic instructions stored in a machine-or computer-readable storage medium such as random access memory (RAM), read only memory (ROM), programmable ROM (PROM), firmware, flash memory, etc., in configurable logic such as, for example, programmable logic arrays (PLAs), field-programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 30 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 32 partitions an input vertex feature matrix into a plurality of groups. In an embodiment, block 34 generates, via a block of the reversible GNN, outputs for the plurality of groups based on an adjacency matrix and an edge feature matrix, wherein the outputs are generated during one or more forward propagations. In one example, block 34 shares weights across two or more layers of the block of the reversible GNN in a group-wise manner. Moreover, block 34 may compute the outputs for the plurality of groups in parallel. Block 36 conducts a reconstruction of the input vertex feature matrix during one or more backward propagations, where block 38 excludes the adjacency matrix and the edge feature matrix from the reconstruction. In an embodiment, the memory complexity of the forward propagation and the backward propagation is independent of the number of layers in the block of the reversible GNN.

FIG. 3B shows a method 31 of generating outputs for a plurality of groups. The method 31 may generally be incorporated into block 34 (FIG. 3A), already shown. More particularly, the method 31 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 33 embeds one or more normalized layers in the block of the reversible GNN. Additionally, block 35 may embed one or more drop out layers in the block of the reversible GNN. In an embodiment, block 37 shares a drop out pattern across two or more of the drop out layers.

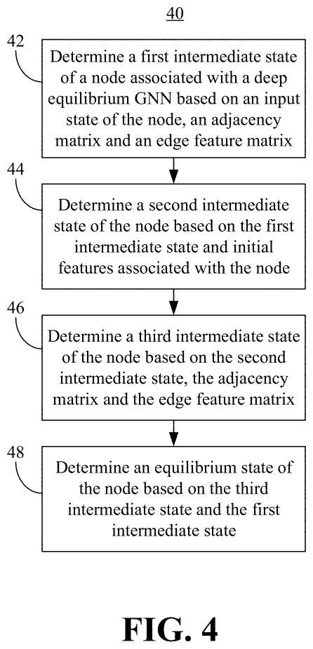

FIG. 4 shows a method 40 of training a deep equilibrium GNN. The method 40 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

Illustrated processing block 42 determines a first intermediate state (e.g., Z′) of a node associated with the deep equilibrium GNN based on an input state of the node, an adjacency matrix and an edge feature matrix. Block 44 determines a second intermediate state (e.g., Z″) of the node based on the first intermediate state and initial features associated with the node. In one example, block 46 determines a third intermediate state of the node based on the second intermediate, the adjacency matrix and the edge feature matrix. Block 48 determines an equilibrium state (e.g., Zₒ) of the node based on the third intermediate state and the first intermediate state.

Results

To evaluate the effectiveness of different techniques, experiments were conducted on several datasets from the Open Graph Benchmark (OGB) (Hu et al. 2020). Embodiments first perform a comprehensive comparison of different approaches on the ogbn-proteins dataset. Embodiments then apply the reversible GNN framework to different GNN operators on the ogbn-arxiv dataset. To show how mini-batch sampling can further aid training deep GNNs, embodiments compare full-batch and mini-batch training of reversible GNNs on the ogbn-products dataset. The data splits and evaluation metrics on all datasets follow the OGB evaluation protocol. Mean and standard deviation are obtained across ten trials. All the ablated models use the same hyper-parameters (e.g., learning rate, drop out rate, training epoch, etc.) and optimizers as the baseline models. The implementation of all the reversible models is based on PyTorch (Paszke et al., 2019) and supports both PyTorch Geometric (PyG) (Fey & Lenssen, 2019) and Deep Graph Libray (DGL) (Wang et al., 2019a) frameworks.

We briefly describe two variants of our RevGNN with reversible connections, which reach new SOTA results on the ogbn-proteins dataset of the OGB leaderboard (Hu et al., 2020) (Table 1) at the time of submission. RevGNN-Deep has 1001 layers and a channel size of 80. It outperforms the previous SOTA method UniMP+CEF by 0.83% ROCAUC, while using only 10.5% of the GPU memory for training. RevGNN-Wide uses 448 GNN layers and 224 hidden channels and significantly outperforms UniMP+CEF by 1.33% ROC-AUC with about 29% of the GPU memory. RevGNN-Deep uses the same training setting as mentioned in Section 3.4. The RevGNN-Wide uses a larger dropout rate of 0:2 to prevent overfitting. To boost the performance, the results of RevGNN-Deep and RevGNN-Wide are obtained using multi-view inferences with 10 views on larger subgraphs with a partition size of 3. We perform the inferences on a NVIDIA RTX A6000 (48 GB). Please refer to the supplement for the details of multi-view inference. Larger and deeper models incur a cost in terms of training and inference time. RevGNN-Deep and RevGNN-Widetake 13.5 days and 17.1 days, respectively, to train for 2000 epochs on a single NVIDIA V100. Nonetheless, it is affordable for accuracy-critical applications in scientific research such as predicting protein structures (Senior et al., 2020). We demonstrate that it is possible to train huge over-parameterized GNN models on a single GPU. The RevGNN-Wide model has 68.47 million parameters, which is about half the size of the GPT language model (Radford et al). The results demonstrate an important step forward in developing over-parameterized GNNs for graphs.

As shown in Table I and the plot 50, the ResGNN with 112 layers and a channel size of 64 achieves around 86% ROC-AUC on ogbn-proteins. However, the memory consumption of ResGNN-64 increases linearly with the number of layers. ResGNN-64 runs out of memory beyond 112 layers, making it impossible to investigate deeper models with current hardware.

TABLE I
Results on the ogbn-proteins Dataset Compared to SOTA

| Model | ROC-AUC↑ | Mems↓ | Params |
|---|---|---|---|
| GCN (Kipf & Welling) | 72.51 ± 0.35 | 4.68 | 96.9k |
| GraphSAGE (Hamilton et al.) | 77.68 ± 0.20 | 3.12 | 193k |
| DeeperGCN (Li et al.) | 86.16 ± 0.16 | 27.1 | 2.37M |
| UniMP (Shi et al.) | 86.42 ± 0.08 | 27.2 | 1.91M |
| GAT (Velic̆ović et al.) | 86.82 ± 0.21 | 6.74 | 1.96M |
| Enhanced (RevGNN-Deep) | 87.74 ± 0.13 | 2.86 | 20.03M |
| Enhanced (RevGNN-Wide) | 88.24 ± 0.15 | 7.91 | 68.47M |

RevGNN-Deep has 1001 layers with 80 channels each. It achieves SOTA performance with minimal GPU memory for training. RevGNN-Wide has 448 layers with 224 channels each. It achieves the best accuracy while consuming a moderate amount of GPU memory.

Our RevGNNs also achieve new SOTA results on the ogbnarxiv dataset (see Table 2). RevGCN-Deep uses 28 GCN (Kipf & Welling, 2017) layers with 128 channels each and achieves an accuracy of 73.01%, while only using 1.84 GB of GPU memory. RevGAT-Wide uses 5 attention layers with 3 heads and 356 channels for each head and outperforms the current top performer UniMP v2 (Shi et al., 2020) (74:05% vs. 73:97%) while using about a third of the memory (8.49 GB vs. 25.0 GB). RevGAT-SelfKD uses selfknowledge distillation (Zhang et al., 2019) with 5 attention layers, 3 heads, and 256 channels each. The teacher models achieve an accuracy of 74:02%. After training with distillation, the student models set a new SOTA with 74:26% test accuracy.

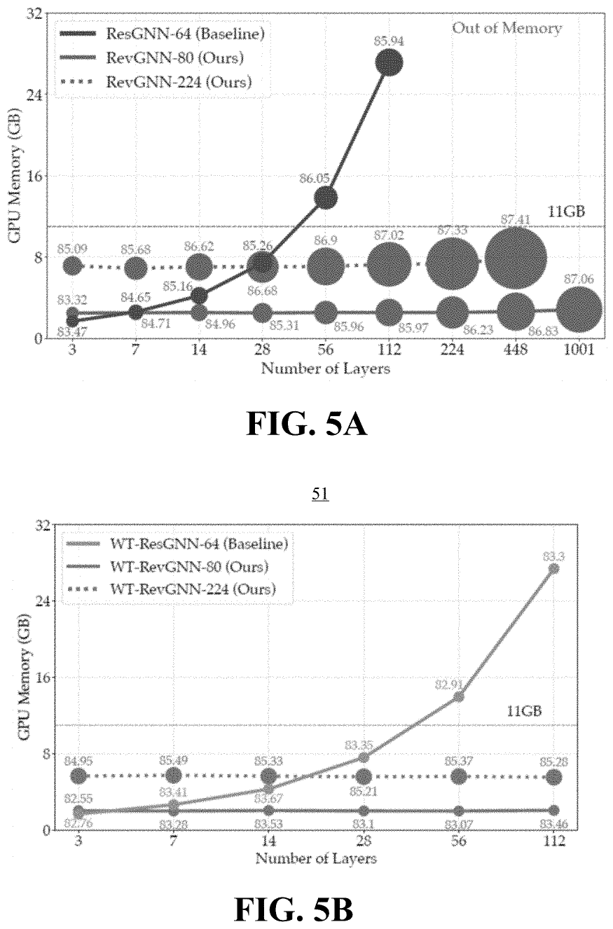

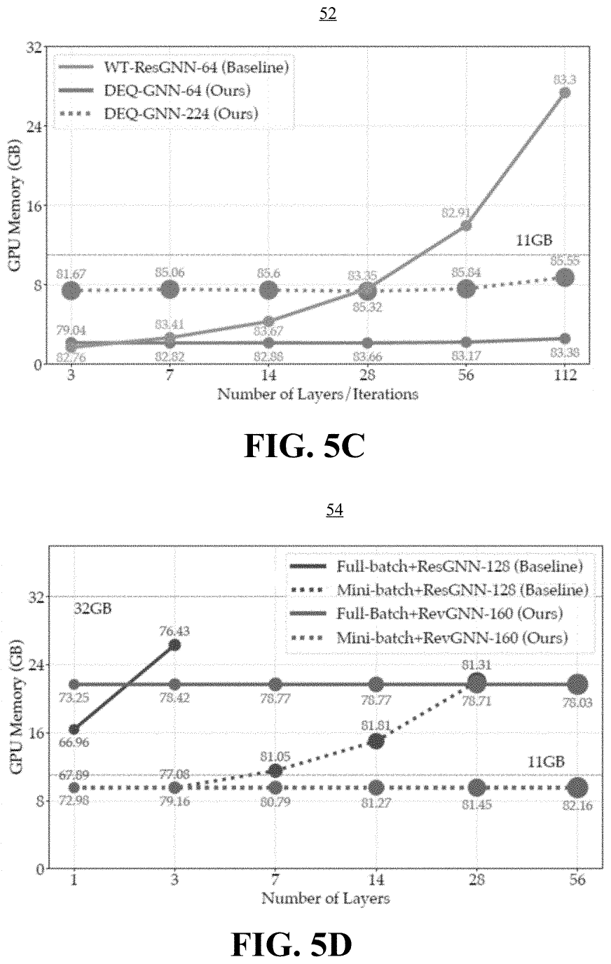

FIG. 5A shows a plot 50 of GPU memory consumption versus number of layers. The plot 50 compares ResGNN (Li et al. 2020) and RevGNN, an adaptation with reversible connections. RevGNN uses constant memory for deeper networks with more parameters and better performance. Widths of 64 and 80 are used for ResGNN and RevGNN, respectively, to ensure a similar number of parameters per network depth. Datapoints are annotated with the ROC-AUC score of the model and the respective datapoint size is proportional to j, where p corresponds to the number of model parameters.

The reversible GNN enables training of very deep networks with constant memory footprint, as illustrated in the neural network architectures 10 in FIG. 1 (RevGNN). Embodiments use a group size of 2; since grouping reduces the number of parameters, RevGNN-80 has roughly the same number of parameters as ResGNN-64 for the same number of layers. While the baseline model ResGNN-64 cannot go beyond 112 layers due to memory limitations, RevGNN-80 can go to more than 1000 layers without additional memory cost and achieves much better accuracy (87.06% ROC-AUC). Embodiments can invest the saved GPU memory to increase the network width and train a higher-capacity model on a single consumer GPU (2080Ti). This model is not only deep (448 layers) but also wide (224 channels). As shown in FIG. 5A (RevGNN-224) and Table III (ResGNN-Wide), this model sets a new SOTA (state of the art, 87.41% ROC-AUC) on ogbn-proteins using less than 8 GB of GPU memory for training.

Embodiments explore weight-tying, which reduces the number of parameters. Since the parameters are shared across GNN layers, the number of parameters stays constant as the number of layers increases. Embodiments compare the weight-tied ResGNN (WT-ResGNN) and weight-tied RevGNN (WT-RevGNN) in a chart 51 of FIG. 5B. WT-ResGNN-64 and WT-RevGNN-80 have approximately the same number of parameters. Embodiments observe that deeper weight-tied GNNs perform slightly better. The performance peaks at 7 to 14 layers. WT-RevGNN-80 achieves similar accuracy to WT-ResGNN-64 with significantly less GPU memory. Thanks to memory and parameter efficiency, WT-RevGNN-224 with 7 layers, reaches a comparable result to ResGNN-64 with 112 layers while using drastically less memory and parameters (Mem: 5.75 GB vs. 27.1 GB, Params: 337k vs. 2.37M).

Equilibrium networks implicitly model a weight-tied network with infinite depth. As a result, they only have the parameter and memory footprint of a single layer, but the expressiveness of a very deep network. The initial node features X are used as input injection and the initial node states Z are set to zero. Embodiments implement our DEQ-GNN based on the original DEQ implementation for CNNs (Bai, Kolter, and Koltun 2019). Broyden's root-finding method is used (Broyden 1965) in both the forward pass and the backward pass to find the equilibrium node states and approximate the inverse Jacobian. The Broyden iterations terminate when the norm of the objective is smaller than a tolerance ε or a maximum iteration threshold is reached. ε is set to 10⁻⁶·\sqrt{BD} and 2×10⁻¹⁰·\sqrt{BD} for the forward pass and the backward pass respectively, where B is the number of nodes in the sampled subgraph and D is the channel size. The iteration thresholds in the forward pass and the backward pass are set as the same value. Embodiments examine different iteration thresholds for DEQ-GNN with a channel size of 64 (DEQ-GNN-64) and a channel size of 224 (DEQ-GNN-224) in a plot 52 of FIG. 5C showing GPU memory versus number of layers/iterations. The plot 52 compares ResGNN with DEQ-GNN. Datapoints are annotated with the ROC-AUC score of the model and their size is proportional to \sqrt{p}, where p corresponds to the number of model parameters.

It can be seen that the iteration threshold is crucial for good performance since it affects the convergence to the equilibrium. As shown in Table I, embodiments find that DEQ-GNN-64 performs similar to WT-RevGNN-80 with nearly the same number of parameters and memory usage while training significantly faster (1.3 days vs. 2 days). The wider DEQ-GNN-224 model reaches 85.84% ROC-AUC, which is comparable to ResGNN-64, with only around 28% memory footprint and 23% parameters (Mem: 7.60 GB vs. 27.1 GB, Params: 537k vs. 2.37M). DEQ-GNN-224 slightly outperforms WT-RevGNN-224 while training almost twice as fast (2.9 days vs. 4.8 days).

Results with different GNN operators on the ogbn-arxiv dataset. All GAT models use label propagation. #L denotes the number of layers and #Ch denotes the number of channels. Baselines are in italics.

TABLE II

| Model | #L | #Ch | ACC↑ | Mem↓ | Params |
|---|---|---|---|---|---|
| ResGCN | 28 | 128 | 72.46 ± 0.29 | 11.15 | 491k |
| RevGCN | 28 | 128 | 73.01 ± 0.31 | 1.84 | 262k |
| RevGCN | 28 | 180 | 73.22 ± 0.19 | 2.73 | 500k |
| ResSAGE | 28 | 128 | 72.46 ± 0.29 | 8.93 | 950k |
| RevSAGE | 28 | 128 | 72.69 ± 0.23 | 1.17 | 491k |
| RevSAGE | 28 | 180 | 72.73 ± 0.10 | 1.57 | 953k |
| ResGEN | 28 | 128 | 72.32 ± 0.27 | 21.63 | 491k |
| RevGEN | 28 | 128 | 72.34 ± 0.18 | 4.08 | 262k |
| RevGEN | 28 | 180 | 72.93 ± 0.10 | 5.67 | 500k |
| ResGAT | 5 | 768 | 73.76 ± 0.13 | 9.96 | 3.87M |
| RevGAT | 5 | 768 | 74.02 ± 0.18 | 6.30 | 2.10M |
| RevGAT | 5 | 1068 | 74.05 ± 0.11 | 8.49 | 3.88M |

Application to Different GNN Operators

The proposed techniques are generic and can in principle be applied to any SOTA GNN to further boost the performance with deeper and wider architectures while saving GPU memory. Embodiments show this for the example of reversible GNNs and build RevGNNs with different SOTA GNN operators: GAT (Veličković et al. 2018), GCN (Kipf and Welling 2017), GraphSAGE (Hamilton, Ying, and Leskovec 2017), and ResGNN (Li et al. 2020)). Embodiments compare them to their non-reversible residual counterparts on the ogbn-arxiv datatset in Table II. Since ogbn-arxiv is much smaller than the ogbn-proteins dataset, embodiments are able to run all experiments with full-batch training and report statistics across ten training runs. Embodiments observe that all of the RevGNNs consistently perform better than the vanilla residual counterparts with the same channel size. The RevGNNs use less memory due to reversible connections and fewer parameters due to grouping. Embodiments increase the channel size of RevGNNs to roughly match the number of parameters of the corresponding ResGNNs, increasing the performance gap further. For instance, the RevGCN with 28 layers and 180 channels reduces the memory footprint by more than 75% while improving the accurracy by 0.76% compared to the ResGCN with 28 layers and 128 channels. Utilizing label propagation, the RevGAT with 5 layers and 1068 channels (3 attention heads with 356 channels for each head) achieves the best result and sets a new SOTA on ogbn-arxiv.

Results on the ogbn-proteins dataset compared to SOTA. RevGNN-Deep has 1001 layers with 80 channel each. It achieves SOTA performance with minimal GPU memory. RevGNN-Wide has 448 layers with 224 channels each. It achieves the best performance by a large margin while consuming a moderate amount of GPU memory.

TABLE III

| Model | ROC-AUC ↑ | Mem ↓ | Params |
|---|---|---|---|
| GCN (Kipf and Welling (2017)) | 72.51 ± 0.35 | 4.68 | 96.9k |
| GraphSAGE (Hamilton, Ying, | 77.68 ± 0.20 | 3.12 | 193k |
| and Leskovec (2017)) | | | |
| DeeperGCN (Li et al. (2020)) | 86.16 ± 0.16 | 27.1 | 2.37M |
| UniMP (Shi et al. (2020)) | 86.42 ± 0.08 | 27.2 | 1.91M |
| GAT (Velic̆lović et al. (2018)) | 86.82 ± 0.21 | 6.74 | 2.48M |
| UniMP + CEF (Shi et al. (2020)) | 86.91 ± 0.18 | 27.2 | 1.96M |
| Ours (RevGNN-Deep) | 87.06 ± 0.14 | 2.86 | 20.03M |
| Ours (RevGNN-Wide) | 87.41 ± 0.14 | 7.91 | 68.47M |

State-of-the-Art Results

Embodiments briefly describe two variants of our RevGNN with reversible connections, that achieve new SOTA results on the ogbn-proteins dataset of the OGB leaderboard (Hu et al. 2020) (Table III). RevGNN-Deep has 1001 layers and a channel size of 80. It outperforms the previous SOTA method UniMP+CEF slightly (0.15% ROC-AUC) while using only 10.5% of the GPU memory for training. RevGNN-Wide uses 448 GNN layers and 224 hidden channels and significantly outperforms UniMP+CEF by 0.5% ROC-AUC with about 29% of the GPU memory. Larger and deeper models incur a cost in terms of training and inference time. Nonetheless, it is affordable for accuracy-critical applications in scientific research such as predicting protein structures (Senior et al. 2020). Embodiments demonstrate that it is possible to train huge overparameterized GNN models on a single GPU. The RevGNN-Wide model has 68.47 million parameters, which is about half the size of the GPT language model (Radford et al., n.d.). Embodiments believe that this is an important step forward in developing over-parameterized GNNs for graphs.

Memory-efficient models also achieve new SOTA results on the ogbn-arxiv dataset (see Table IV). RevGCN-Deep uses 28 GCN layers with 128 channels each and achieves an accuracy of 73.01% while using only 1.84 GB of GPU memory. RevGAT-Wide uses 5 attention layers with 3 heads and 356 channels for each head and outperforms the current top performer UniMP_v2 (Shi et al. (2020)) (74.05 vs. 73.97) while using about a third of the memory (8.49 GB vs. 25.0 GB).

Results on the ogbn-arxiv dataset compared to SOTA. RevSAGE-Deep has 28 layers with 180 channel each. It achieves SOTA performance with minimal GPU memory. RevGAT-Wide has 5 layers with 1068 channels each. It achieves the best performance while consuming a moderate amount of GPU memory.

TABLE IV

| Model | ACC ↑ | Mem ↓ | Params |
|---|---|---|---|
| GraphSAGE (Hamilton, Ying, | 71.49 ± 0.27 | 1.99 | 219k |
| and Leskovec (2017)) | | | |
| GCN (Kipf and Welling (2017)) | 71.74 ± 0.29 | 1.90 | 143k |
| DAGNN (Liu, Gao, and Ji (2020)) | 72.09 ± 0.25 | 2.40 | 43.9k |
| DeeperGCN (Li et al. (2020)) | 72.32 ± 0.27 | 21.6 | 491k |
| GCNII (Chen etal. (2020)) | 72.74 ± 0.16 | 17.0 | 2.15M |
| GAT (Velic̆lović etal. (2018)) | 73.91 ± 0.12 | 5.52 | 1.44M |
| UniMP_v2 (Shi et al. (2020)) | 73.97 ± 0.15 | 25.0 | 687k |
| Ours (RevGCN-Deep) | 73.01 ± 0.31 | 1.84 | 262k |
| Ours (RevGAT-Wide) | 74.05 ± 0.11 | 8.49 | 3.88M |

### DISCUSSION

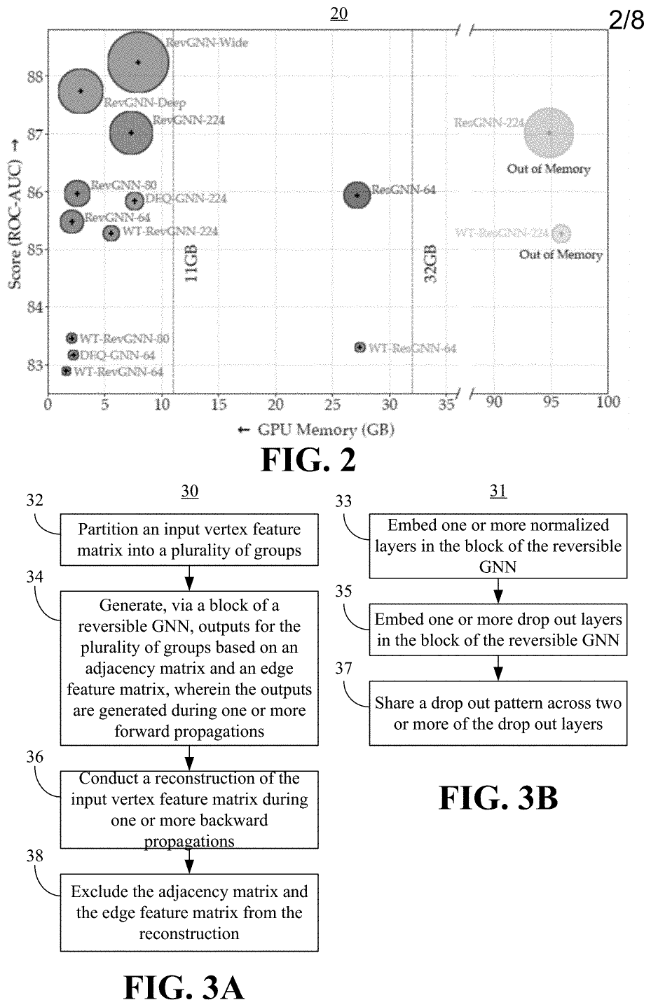

Results are summarized in a plot 20 in FIG. 2. The reversible networks consume much less memory while achieving comparable performance as the baseline methods when using the same number of parameters. However, while the baseline method quickly runs out of memory, embodiments are able to train very deep networks with more parameters and much better performance. While it is possible to go to arbitrary depths with constant memory consumption, the training time increases. In order to reduce the number of parameters and inference time, it is possible to increase the group size. However, embodiments find that group sizes larger than two do not lead to a performance increase in practice and may even degrade model performance. Embodiments conjecture that this is due to the increased receptive field of early layers and the smaller number of parameters per memory. Embodiments provide an ablation study in the supplement.

The weight-tied network limits the number of parameters to a single layer regardless of the effective depth. Embodiments find that going deeper with tied weights boost performance, but returns eventually diminish (see FIG. 5B). While parameters stay constant, going deeper still increases memory consumption, unless the reversible GNN block is used. An extension of the weight-tied network is the graph equilibrium model, which represents an infinite-depth weight-tied network and uses fixed-point iterations to solve for the optimal weights. This allows for much wider channel size with the same amount of memory. DEQ-GNNs are faster to train, but have more hyper-parameters to tune. Embodiments find that pretraining is not necessary, but can help. The results reported in this paper are without pretraining for fair comparison.

The illustrated method is orthogonal to existing sampling-based approaches to reducing memory consumption. Hence, embodiments can use the illustrated techniques in conjunction with mini-batch training to further optimize memory. Embodiments conduct an ablation study on the ogbn-products dataset (Hu et al. 2020) with full-batch training and a simple random-clustering mini-batch training for ResGNNs and RevGNNs. The results are reported in a plot 54 of FIG. 5D, which shows GPU memory consumption versus number of layers. The plot 54 compares ResGNN (Li et al. 2020) and RevGNN with full-batch and mini-batch training on the ogbn-products dataset. RevGNN uses constant memory for deeper networks with more parameters and better performance. The illustrated example uses widths 128 and 160 for ResGNN and RevGNN, respectively, to ensure a similar number of parameters per network depth. Datapoints are annotated with the accuracy of the model and their size is proportional to j, where p corresponds to the number of model parameters. Embodiments find that mini-batch training further reduces the memory consumption of RevGNN to 44% and improves the accuracy by around 3.4%.

Grouping of RevGNNs

Grouped convolution is an effective way to reduce the parameter complexity in CNNs. Embodiments provide an ablation study to show how grouping can reduce parameters of RevGNNs. Embodiments conduct experiments on ogbn-proteins with different group sizes in Table I. The number of hidden channels for all the models is set as 224. Embodiments find that a larger group size reduces the number of parameters. As the group size increases from 2 to 4, the number of parameters reduces more than 30%. The performance of models with 3 to 56 layers decreases slightly. For the 112-layer networks, they achieve the same performance while the model with group size as 4 uses only around 67% parameters of the model with group size as 2. However, embodiments observe that the GPU memory usage increases from 7.30 GB to 11.05 GB as the group size increases from 2 to 4 with our current implementation. Embodiments conjecture this is due to the inefficient implementation. Embodiments leave it for a future investigation.

Ablation on the group size of group reversible GNNs on ogbn-protein. L is the number of layers. The number of hidden channels is 224 for all the models.

TABLE V

| | Group = 2 | | Group = 4 | |
|---|---|---|---|---|
| #L | Params | ROC-AUC | Params | ROC-AUC |
| 3 | 490k | 85.09 | 339k | 84.86 |
| 7 | 1.1M | 85.68 | 750k | 85.25 |
| 14 | 2.2M | 86.62 | 1.5M | 85.79 |
| 28 | 4.3M | 86.68 | 2.9M | 86.30 |
| 56 | 8.6M | 86.90 | 5.8M | 86.76 |
| 112 | 17.2M | 87.02 | 11.5M | 87.09 |

Analysis of Complexities

Embodiments have discussed the memory complexity of full-batch GNNs, GraphSAGE (Hamilton, Ying, and Leskovec 2017), VR-GCN (Jianfei Chen, Zhu, and Song 2018), FastGCN (Jie Chen, Ma, and Xiao 2018), Cluster-GCN (Chiang et al. 2019) and GraphSAINT (Zeng et al. 2020) in the related work section, and the memory complexity of Reversible GNN, Weight-tied GNN and DEQ-GNN in the methodology section. Here the theoretical memory complexity is summarized in Table VI, where L is the number of layers of GNN, D is the size of hidden channels, N is of the number of nodes in the graph, B is the batch size of nodes and R is the number of sampled neighbors of each node. K is the maximum Broyden iterations for equilibrium GNNs. Note that embodiments only discuss the memory complexity for storing intermediate node features in each layer since the memory footprint of the network parameters is negligible. All the prior works suffer from memory consumption with respect to the number of layers, while the memory consumption of our methods is independent of the depth. Our methods can also be combined with mini-batch sampling methods to further reduce the memory complexity with respect to the number of nodes. Embodiments also include the parameter complexity and time complexity in Table 6. Note that although the time complexity of RevGNN stay the same as vanilla GNNs. RevGNN has a larger constant term due to the input is needed to be reconstructed during the backward pass. Both the memory complexity and parameter complexity of WT-ResGNN and DEQ-GNN is independent of L.

TABLE VI

| Method | Memory | Params | Time |
|---|---|---|---|
| Full-batch GNN | [symbol] (LND) | [symbol] (LD²) | [symbol] (L∥A∥₀D + LND²) |
| GraphSAGE | [symbol] (R^{L}BD) | [symbol] (LD²) | [symbol] (R^{L}ND²) |
| VR-GCN | [symbol] (LND) | [symbol] (LD²) | [symbol] (L∥A∥₀D + LND² + R^{L}ND²) |
| FastGCN | [symbol] (LRBD) | [symbol] (LD²) | [symbol] (RLND²) |
| Cluster-GCN | [symbol] (LBD) | [symbol] (LD²) | [symbol] (L∥A∥₀D + LND²) |
| GraphSAINT | [symbol] (LBD) | [symbol] (LD²) | [symbol] (L∥A∥₀D + LND²) |
| Weight-tied GNN | [symbol] (LND) | [symbol] (D²) | [symbol] (L∥A∥₀D + LND²) |
| RevGNN | [symbol] (ND) | [symbol] (LD²) | [symbol] (L∥A∥₀D + LND²) |
| WT-RevGNN | [symbol] (ND) | [symbol] (D²) | [symbol] (L∥A∥₀D + LND²) |
| DEQ-GNN | [symbol] (ND) | [symbol] (D²) | [symbol] (K∥A∥₀D + KND²) |
| RevGNN + Subgraph Sampling | [symbol] (BD) | [symbol] (LD²) | [symbol] (L∥A∥₀D + LND²) |
| WT-RevGNN + Subgraph | [symbol] (BD) | [symbol] (D²) | [symbol] (L∥A∥₀D + LND²) |
| Sampling | | | |
| DEQ-GN + Subgraph Sampling | [symbol] (BD) | [symbol] (D²) | [symbol] (K∥A∥₀D + KND²) |

### Details about Experiments

Datasets and Frameworks

Experiment were conducted on three OGB datasets (Hu et al. 2020) including ogbn-proteins, ogbn-arxiv and ogbn-products. The standard data splits and evaluation protocol of OGB 1.2.4 are followed. Regrading the deep learning frameworks, Pytorch 1.6.0 is used. Pytorch Geometric 1.6.1 is used for all the experiments except the experiments of GATs where DGL 0.5.3 is used.

Hyperparameters and Training Settings

Embodiments describe the important hyperparameters and training settings that have not been mentioned in the main paper for re-productivity. The settings are different from datasets:

The node features are initialized through aggregating connected edge features by a Sum aggregation at the first layer. Random partitioning is used for mini-batch training. The number of partitions is set to 10 for training and 5 for test. One subgraph is sampled at each SGD step. One layer normalization is used in the GNN block. A drop out with a rate of 0.1 are used for each layer. Max is used as the message aggregator. The model is trained for 2000 epochs with an Adam optimizer with a learning rate of 0.001.

The directed graph is converted into undirected and self-loop is added. Embodiments use full batch for both training and test. For the GCN, SAGE and GEN models, a batch normalization is applied for each layer, a drop out with a rate of 0.5 is used for each layer and an Adam optimizer with a learning rate of 0.001 is used to train the models for 2000 epochs. For the GAT models, embodiments implement them based on the OGB leaderboard submission of GAT+norm. adj.+label reuse. Please refer to the web site for more details.

Self-loop is added to the graph. Embodiments compare RevGNNs with full-batch training and mini-batch training. For mini-batch training, the graph is randomly partitioned into 10 subgraphs and one subgraph is sampled at each SGD step. Full-batch test is used in both scenarios. A batch normalization and a drop out with a rate of 0.5 are used for each GNN block. The model is trained with an Adam optimizer with a learning rate of 0.001 for 1000 epochs.

GPU Memory Measurement

In all the experiments, the GPU memory usage is measured by the peak GPU memory during the first training epoch. In practice, torch.cuda.max_memory_allocated( ) is used. Note that the measured GPU memory is larger than the GPU memory for storing node features since the intermediate computation and network parameters. However, embodiments consider the peak GPU memory usage as a practical metric since it is the bottleneck for training neural networks.

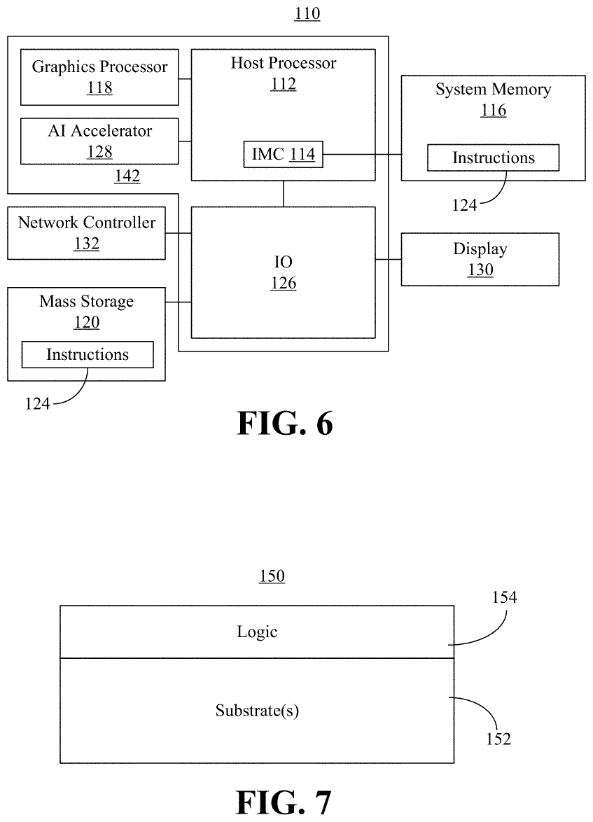

Turning now to FIG. 6, a performance-enhanced computing system 110 is shown. The system 110 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 110 includes a host processor 112 (e.g., CPU) having an integrated memory controller (IMC) 114 that is coupled to a system memory 116 (e.g., dual inline memory module/DIM M). In an embodiment, an IO module 126 is coupled to the host processor 112. The illustrated IO module 126 communicates with, for example, a display 130 (e.g., touch screen, liquid crystal display/LCD, light emitting diode/LED display), and a network controller 132 (e.g., wired and/or wireless). The host processor 112 may be combined with the 10 module 126 and a graphics processor 118 into a system on chip (SoC) 142. The illustrated system 110 also includes an accelerator 128 coupled to the host processor 112 via an interface.

In an embodiment, the host processor 112 executes a set of program instructions 124 retrieved from mass storage 120 and/or the system memory 116 to perform one or more aspects of the method 30 (FIG. 3A), the method 31 (FIG. 3B) and/or the method 40 (FIG. 4), already discussed.

FIG. 7 shows a semiconductor apparatus 150 (e.g., chip, die, package). The illustrated apparatus 150 includes one or more substrates 152 (e.g., silicon, sapphire, gallium arsenide) and logic 154 (e.g., transistor array and other integrated circuit/IC components) coupled to the substrate(s) 152. In an embodiment, the logic 154 implements one or more aspects of the method 30 (FIG. 3A), the method 31 (FIG. 3B) and/or the method 40 (FIG. 4), already discussed.

The logic 154 may be implemented at least partly in configurable logic or fixed-functionality hardware logic. In one example, the logic 154 includes transistor channel regions that are positioned (e.g., embedded) within the substrate(s) 152. Thus, the interface between the logic 154 and the substrate(s) 152 may not be an abrupt junction. The logic 154 may also be considered to include an epitaxial layer that is grown on an initial wafer of the substrate(s) 152.

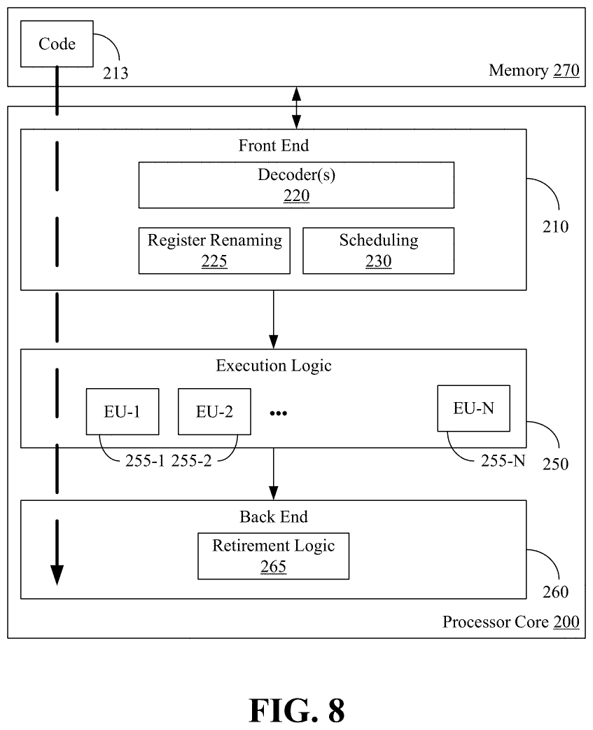

FIG. 8 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 8, a processing element may alternatively include more than one of the processor core 200 illustrated in FIG. 8. The processor core 200 may be a single-threaded core or, for at least one embodiment, the processor core 200 may be multithreaded in that it may include more than one hardware thread context (or “logical processor”) per core.

FIG. 8 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 30 (FIG. 3A), the method 31 (FIG. 3B) and/or the method 40 (FIG. 4), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 8, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

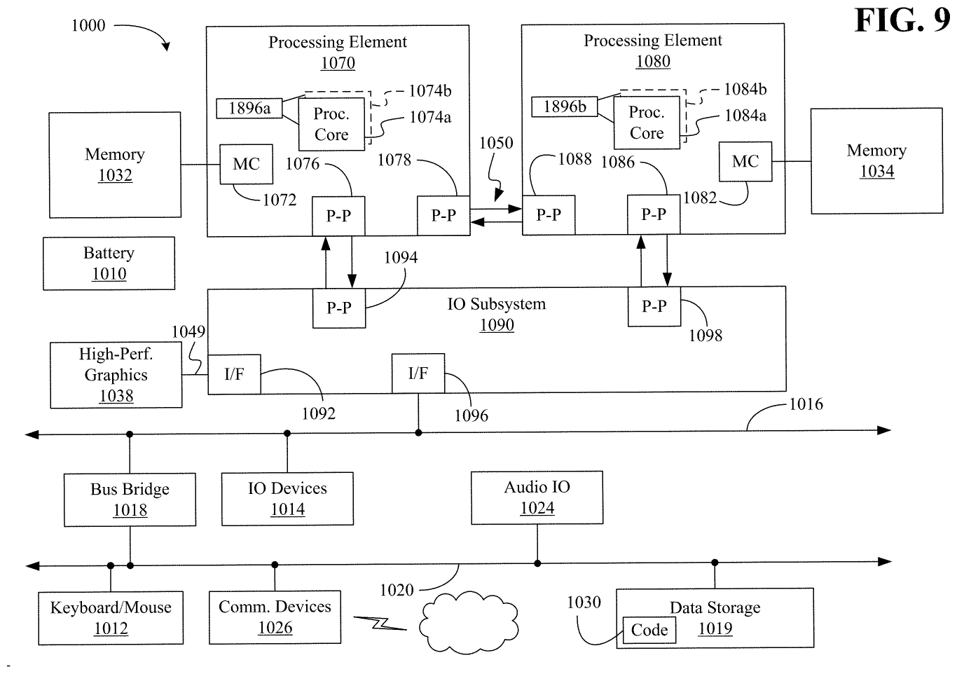

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 30 (FIG. 3A), the method 31 (FIG. 3B) and/or the method 40 (FIG. 4), already discussed. Further, an audio I/O 1024 may be coupled to second bus 1020 and a battery 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9.

### ADDITIONAL NOTES AND EXAMPLES

Example 1 includes a semiconductor apparatus to train a reversible graph neural network (GNN), the semiconductor apparatus comprising one or more substrates and logic coupled to the one or more substrates, wherein the logic is implemented at least partly in one or more of configurable logic or fixed-functionality hardware logic, the logic coupled to the one or more substrates to partition an input vertex feature matrix into a plurality of groups, generate, via a block of the reversible GNN, outputs for the plurality of groups based on an adjacency matrix and an edge feature matrix, wherein the outputs are generated during one or more forward propagations, conduct a reconstruction of the input feature matrix during one or more backward propagations, and exclude the adjacency matrix and the edge feature matrix from the reconstruction.

Example 2 includes the semiconductor apparatus of claim 1, wherein the logic coupled to the one or more substrates is to share weights across two or more layers of the block of the reversible GNN.

Example 3 includes the semiconductor apparatus of claim 2, wherein the weights are shared in a group-wise manner.

Example 4 includes the semiconductor apparatus of claim 1, wherein to generate the outputs, the logic coupled to the one or more substrates is to embed one or more normalized layers in the block of the reversible GNN, and embed one or more drop out layers in the block of the reversible GNN.

Example 5 includes the semiconductor apparatus of claim 4, wherein the logic coupled to the one or more substrates is to share a drop out pattern across two or more of the drop out layers.

Example 6 includes the semiconductor apparatus of claim 1, wherein the outputs are computed for the plurality of groups in parallel.

Example 7 includes the semiconductor apparatus of any one of claims 1 to 6, wherein a memory complexity of the forward propagation and the backward propagation is independent of a number of layers in the block of the reversible GNN.

Example 8 includes the semiconductor apparatus of any one of claims 1 to 6, wherein the logic coupled to the one or more substrates includes transistor channel regions that are positioned within the one or more substrates.

Example 9 includes at least one computer readable storage medium comprising a set of instructions to train a reversible graph neural network (GNN), wherein when executed by a computing system, the set of instructions cause the computing system to partition an input vertex feature matrix into a plurality of groups, generate, via a block of the reversible GNN, outputs for the plurality of groups based on an adjacency matrix and an edge feature matrix, wherein the outputs are generated during one or more forward propagations, conduct a reconstruction of the input vertex feature matrix during one or more backward propagations, and exclude the adjacency matrix and the edge feature matrix from the reconstruction.

Example 10 includes the at least one computer readable storage medium of claim 9, wherein the instructions, when executed, further cause the computing system to share weights across two or more layers of the block of the reversible GNN.

Example 11 includes the at least one computer readable storage medium of claim 10, wherein the weights are shared in a group-wise manner.

Example 12 includes the at least one computer readable storage medium of claim 9, wherein to generate the outputs, the instructions, when executed, further cause the computing system to embed one or more normalized layers in the block of the reversible GNN.

Example 13 includes the at least one computer readable storage medium of claim 9, wherein to generate the outputs, the instructions, when executed, further cause the computing system to embed one or more drop out layers in the block of the reversible GNN.

Example 14 includes the at least one computer readable storage medium of claim 13, wherein the instructions, when executed, further cause the computing system to share a drop out pattern across two or more of the drop out layers.

Example 15 includes the at least one computer readable storage medium of claim 9, wherein the outputs are computed for the plurality of groups in parallel.

Example 16 includes the at least one computer readable storage medium of any one of claims 9 to 15, wherein a memory complexity of the forward propagation and the backward propagation is independent of a number of layers in the block of the reversible GNN.

Example 17 includes a semiconductor apparatus to train a deep equilibrium graph neural network (GNN), the semiconductor apparatus comprising one or more substrates, and logic coupled to the one or more substrates, wherein the logic is implemented at least partly in one or more of configurable logic or fixed-functionality hardware logic, the logic coupled to the one or more substrates to determine a first intermediate state of a node associated with the deep equilibrium GNN based on an input state of the node, an adjacency matric and an edge feature matrix, determine a second intermediate state of the node based on the first intermediate state and initial features associated with the node, determine a third intermediate state of the node based on the second intermediate state, the adjacency matrix and the edge feature matrix, and determine an equilibrium state of the node based on the third intermediate state and the first intermediate state.

Example 18 includes the semiconductor apparatus of claim 17, wherein the logic coupled to the one or more substrates is to initialize the input state to zeroes for an initial iteration.

Example 19 includes the semiconductor apparatus of any one of claims 17 to 18, wherein the logic coupled to the one or more substrates is to share weights across two or more layers of a block of the deep equilibrium GNN.

Example 20 includes the semiconductor apparatus of any one of claims 17 to 18, wherein the logic coupled to the one or more substrates includes transistor channel regions that are positioned within the one or more substrates.

Example 21 includes at least one computer readable storage medium comprising a set of instructions to train a deep equilibrium graph neural network (GNN), wherein when executed by a computing system, the set of instructions cause the computing system to determine a first intermediate state of a node associated with the deep equilibrium GNN based on an input state of the node, an adjacency matric and an edge feature matrix, determine a second intermediate state of the node based on the first intermediate state and initial features associated with the node, determine a third intermediate state of the node based on the second intermediate state, the adjacency matrix and the edge feature matrix, and determine an equilibrium state of the node based on the third intermediate state and the first intermediate state.

Example 22 includes the at least one computer readable storage medium of claim 21, wherein the instructions, when executed, further cause the computing system to initialize the input state to zeroes for an initial iteration.

Example 23 includes the at least one computer readable storage medium of claim 21, wherein the instructions, when executed, further cause the computing system to share weights across two or more layers of a block of the deep equilibrium GNN.

Technology described herein may also be used to embed digital watermarks. The watermark can be any binary data on selected layers of the model where the weight distributions will go through a matrix multiplication to get desired number of bits of information. In such a case, both weights and transformation are updated through a designed loss function.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A semiconductor apparatus to train a reversible graph neural network (GNN), the semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
partition an input vertex feature matrix into a plurality of groups;
generate, via a block of the reversible GNN, outputs for the plurality of groups based on an adjacency matrix and an edge feature matrix, wherein the outputs are generated during one or more forward propagations;
conduct a reconstruction of the input vertex feature matrix during one or more backward propagations; and
exclude the adjacency matrix and the edge feature matrix from the reconstruction.

2. The semiconductor apparatus of claim 1, wherein the logic coupled to the one or more substrates is to share weights across two or more layers of the block of the reversible GNN.

3. The semiconductor apparatus of claim 2, wherein the weights are shared in a group-wise manner.

4. The semiconductor apparatus of claim 1, wherein to generate the outputs, the logic coupled to the one or more substrates is to:
embed one or more normalized layers in the block of the reversible GNN; and
embed one or more drop out layers in the block of the reversible GNN.

5. The semiconductor apparatus of claim 4, wherein the logic coupled to the one or more substrates is to share a drop out pattern across two or more of the drop out layers.

6. The semiconductor apparatus of claim 1, wherein the outputs are computed for the plurality of groups in parallel.

7. The semiconductor apparatus claim 1, wherein a memory complexity of the forward propagation and the backward propagation is independent of a number of layers in the block of the reversible GNN.

8. The semiconductor apparatus of claim 1, wherein the logic coupled to the one or more substrates includes transistor channel regions that are positioned within the one or more substrates.

9. At least one computer readable storage medium comprising a set of instructions to train a reversible graph neural network (GNN), wherein when executed by a computing system, the set of instructions cause the computing system to:
partition an input vertex feature matrix into a plurality of groups;
generate, via a block of the reversible GNN, outputs for the plurality of groups based on an adjacency matrix and an edge feature matrix, wherein the outputs are generated during one or more forward propagations;
conduct a reconstruction of the input vertex feature matrix during one or more backward propagations; and
exclude the adjacency matrix and the edge feature matrix from the reconstruction.

10. The at least one computer readable storage medium of claim 9, wherein the instructions, when executed, further cause the computing system to share weights across two or more layers of the block of the reversible GNN.

11. The at least one computer readable storage medium of claim 10, wherein the weights are shared in a group-wise manner.

12. The at least one computer readable storage medium of claim 9, wherein to generate the outputs, the instructions, when executed, further cause the computing system to embed one or more normalized layers in the block of the reversible GNN.

13. The at least one computer readable storage medium of claim 9, wherein to generate the outputs, the instructions, when executed, further cause the computing system to embed one or more drop out layers in the block of the reversible GNN.

14. The at least one computer readable storage medium of claim 13, wherein the instructions, when executed, further cause the computing system to share a drop out pattern across two or more of the drop out layers.

15. The at least one computer readable storage medium of claim 9, wherein the outputs are computed for the plurality of groups in parallel.

16. The at least one computer readable storage medium of claim 9, wherein a memory complexity of the forward propagation and the backward propagation is independent of a number of layers in the block of the reversible GNN.

17. A semiconductor apparatus to train a deep equilibrium graph neural network (GNN), the semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
determine a first intermediate state of a node associated with the deep equilibrium GNN based on an input state of the node, an adjacency matric and an edge feature matrix;
determine a second intermediate state of the node based on the first intermediate state and initial features associated with the node;
determine a third intermediate state of the node based on the second intermediate state, the adjacency matrix and the edge feature matrix; and
determine an equilibrium state of the node based on the third intermediate state and the first intermediate state.

18. The semiconductor apparatus of claim 17, wherein the logic coupled to the one or more substrates is to initialize the input state to zeroes for an initial iteration.

19. The semiconductor apparatus of claim 17, wherein the logic coupled to the one or more substrates is to share weights across two or more layers of a block of the deep equilibrium GNN.

20. The semiconductor apparatus of claim 17, wherein the logic coupled to the one or more substrates includes transistor channel regions that are positioned within the one or more substrates.

21. At least one computer readable storage medium comprising a set of instructions to train a deep equilibrium graph neural network (GNN), wherein when executed by a computing system, the set of instructions cause the computing system to:
determine a first intermediate state of a node associated with the deep equilibrium GNN based on an input state of the node, an adjacency matric and an edge feature matrix;
determine a second intermediate state of the node based on the first intermediate state and initial features associated with the node;
determine a third intermediate state of the node based on the second intermediate state, the adjacency matrix and the edge feature matrix; and
determine an equilibrium state of the node based on the third intermediate state and the first intermediate state.

22. The at least one computer readable storage medium of claim 21, wherein the instructions, when executed, further cause the computing system to initialize the input state to zeroes for an initial iteration.

23. The at least one computer readable storage medium of claim 21, wherein the instructions, when executed, further cause the computing system to share weights across two or more layers of a block of the deep equilibrium GNN.
